(19) United States
(12) Patent Application Publication
(10) Pub. No.: US 2024/0382857 A1
(43) Pub. Date: Nov. 21, 2024

(54) VIDEO GAME AND METHOD FOR SAFETY AND WELL-BEING OF FOSTER KIDS

(71) Applicant: Sandra Daniels, Desoto, TX (US)

(72) Inventor: Sandra Daniels, Desoto, TX (US)

(21) Appl. No.: 18/664,187

(22) Filed: May 14, 2024

Related U.S. Application Data
(60) Provisional application No. 63/502,366, filed on May 15, 2023.

(51) Int. Cl. A63F 13/80

(52) U.S. Cl. CPC A63F 13/80

(57) ABSTRACT

To improve safety and well-being a foster kids, a set of questions, optionally embodied in a video game on a mobile electronic device, to enable to foster children to answer the set of questions so as to self-report and real-time is provided. The self-reporting in real-time via the mobile electronic device allows for an agency to monitor foster children in a manner that improves truthfulness of the foster children without typical reluctance or false statements of the foster children. The video game may be configured in a manner that is age-dependent so that the foster kids at different ages feel a sense of security and honesty when playing the game, thereby providing more truthful answers than otherwise. Case workers or intelligent automated systems may consider the answers to determine the well-being and safety of the foster kids presently and trend over time.

### RELATED APPLICATIONS

This Application claims the benefit of priority under 35 U.S.C. § 119(a) of U.S. Provisional Patent Application Ser. No. 63/502,366, titled “Video Game and Method for Safety and Well-Being of Foster Kids,” which is incorporated by reference herein in its entirety for all purposes.

### BACKGROUND

Foster children who are in residential care, such as a foster home, are subject to a variety of emotional, physical, and sociological challenges that need to be monitored. Foster care agencies are test with ensuring that foster children are properly cared for, and case managers or staff make visits to the residences of the foster children to personally monitor the children. The foster children, as with most kids, are hesitant to open up about their true feelings to adults, especially if the children are not confident whether or not their answers will be shared with current caregivers or many other reasons.

In addition, foster children have a variety of emotional needs that are better suited with caregivers, such as foster parents, with certain styles and/or personalities. Knowing which foster kids align with which foster parents is difficult, and, thus, generally not performed. As such, there is a need to establish techniques for determining how best to place children with caregivers.

### BRIEF SUMMARY

To improve safety and well-being a foster kids, a set of questions, optionally embodied in a video game on a mobile electronic device, to enable to foster children to answer the set of questions so as to self-report and real-time is provided. The self-reporting in real-time via the mobile electronic device allows for an agency to monitor foster children in a manner that improves truthfulness of the foster children without typical reluctance or false statements of the foster children. The video game may be configured in a manner that is age-dependent so that the foster kids at different ages feel a sense of security and honesty when playing the game, thereby providing more truthful answers than otherwise.

One embodiment of a method for protecting foster kids may include communicating, via a communications network, a set of questions for a foster child to self-report in real-time about his or her well-being within residential care by answering the questions via a mobile electronic device. Answers from the foster child who is self-reporting in real-time may be received via the communications network from the mobile electronic device. An indicia may be captured by the mobile electronic device, from the foster child when the foster child is answering the questions, thereby providing a validation that the foster child self-reported in real-time.

One embodiment of a method of operating a video game for protecting foster kids may include enabling a foster child to select a game character. An interactive video game environment in which the selected game character is to interact to enable the foster child to self-report in real-time answers to questions about his or her well-being and safety on a mobile electronic device may be established. Answers to the well-being and safety questions in response to the foster child controlling the selected game character in the video game environment may be received. A determination that the foster child's well-being and safety based on his or her answers while playing the video game may be made.

One embodiment of a video game for protecting foster kids may include a selectable a game character for a foster child to select, an interactive video game environment in which the selected game character is to interact to enable the foster child to self-report in real-time answers to questions about his or her well-being and safety on a mobile electronic device, input features for the foster child to submit answers to the well-being and safety questions in response to the foster child controlling the selected game character in the video game environment, and a module configured to process the foster child's well-being and safety based on his or her answers while playing the video game.

### BRIEF DESCRIPTION OF THE DRAWINGS

FIG. 1 is an image of an illustrative environment in which foster children are kept in residential child care (e.g., foster home or facility) and monitored by agency workers in accordance with the principles provided herein;

FIG. 2 is a network environment in which foster children who are visited by case workers can answer questions, optionally embedded into a video game, thereby providing the foster children with a “safe space” to honestly answer the questions that may thereafter be used by the agency to ensure safety and well-being of the foster kids;

FIGS. 3A-3N (collectively FIG. 3) are screen shots of an illustrative video game in which questions are able to be asked of foster kids, thereby allowing the foster kids to self-report in real-time;

FIG. 4 is a flow diagram of an illustrative process for foster kids to play games on a mobile electronic device when answering questions for use in ensuring the foster kids' safety and well-being while in residential child care; and

FIG. 5 is a flow diagram of an illustrative process for operating a video game.

### DETAILED DESCRIPTION

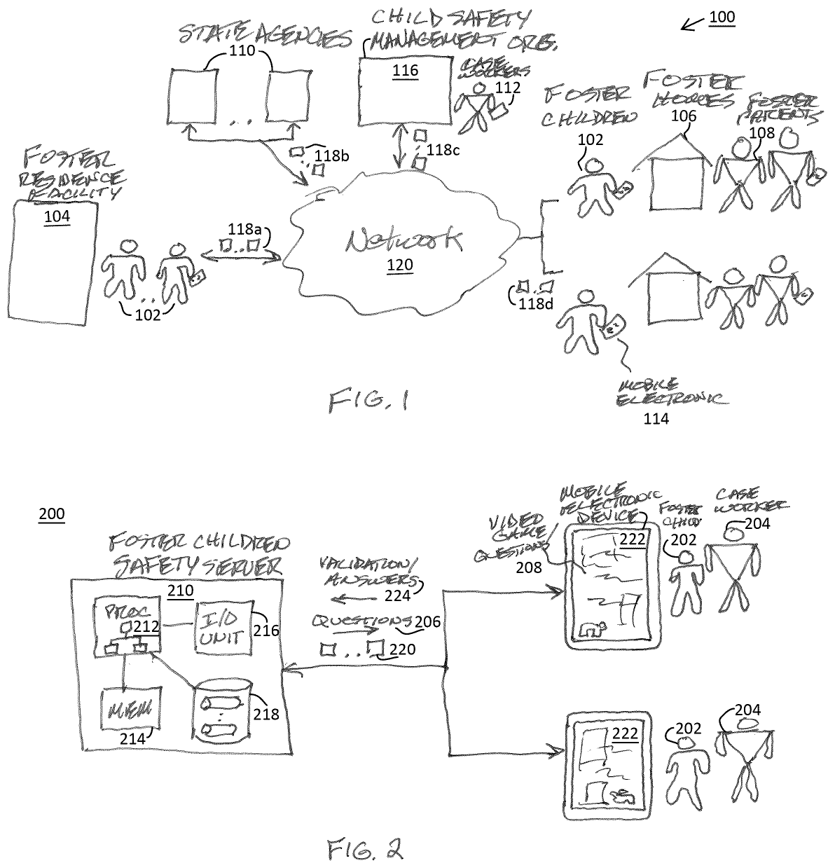

With regard to FIG. 1, an image of an illustrative environment 100 in which foster children 102 are kept in residential child care 104 (e.g., foster home or facility 106) and monitored by agency workers in accordance with the principles provided herein is shown. Foster children 102 are placed into residential child care 104, such as foster homes 106, with caregivers. The caregivers may be facility staff or foster parents 108. As understood, the foster children 102 are monitored by state agencies 110, and case workers 112 are to make visits to the foster children 102 during routine in-person visits. When the case workers 112 visit the foster children 102, the case workers 112 are to assess the children's safety and well-being. The problem is, however, that children are not always, and sometimes seldom, truthful for a variety of reasons. The reasons may range from the kids being kids to the kids being in dangerous environments.

To improve the ability for the case workers 112 to collect more truthful answers from the foster children 102, questions, optionally embedded into a video game, may be utilized to enable the foster children 102 to answer the questions in a self-reporting, real-time manner such that the children 102 feel safe in answering the questions. If embedded in a video game, the foster children 102 may feel especially safe in answering the questions, thereby providing even more truthful answers.

As shown, the foster children 102 in the foster homes 106 may have foster parents 108. The foster children 102, when visited by the case workers 112, may be provided with a mobile electronic device 114 of the case worker 112 to answer the questions and/or play the video game. By providing the mobile electronic device 114 of the case worker 112, a confirmation that the case worker 112 is actually visiting with the foster child/children 102 may be made. In an embodiment, the mobile electronic device 114 may be configured to capture or collect an indicia of or from the foster child 102 when the foster child 102 is answering the questions or playing the video game. The indicia of or from the foster child 102 may include a photograph, video, audio, answer to one or more questions previously selected by the child 102 (e.g., favorite color, favorite animal, first pet name, etc.), and/or otherwise. By capturing the indicia of the foster child 102, the agency 110 may confirm that the foster child 102 is actually self-reporting in a real-time manner. By self-reporting in real-time, the ability for the foster child 102 to change or forget how he or she was feeling at an earlier time may be eliminated. Moreover, by the foster child 102 self-reporting, legal issues may be avoided at the time and/or in the future in the event that the foster child 102 has a different recollection of his or her experience with the foster care and/or case worker 112.

As further shown the caregivers may also provide answers to questions to help establish a corresponding submission of how the caregivers view the situation of the foster child or children 102. In an embodiment, the questions for the caregivers (e.g., foster parents 108) may be about themselves, their premises, their self-reporting abilities to care for the foster child or children 102, their personalities, their financial, emotional, or physical well-being, their likes and dislikes, their ability to teach and mentor children in different subjects or areas of interest of the foster children 102, and so on. The information provided by the caregivers may be used in some manner to compare to the answers of the foster children 102 so that the case worker 112 and/or state agency 110 can assess a situation, positive or negative, of the foster child or children 102. In an embodiment, an artificial intelligence (AI) and/or machine learning (ML) engine may be used to try and match foster children 102 with potential caregivers, thereby improving the ability for foster children 102 to have successful placements with caregivers. The AI and/or ML engine may be executed by a computing system, where the computing system may operate in the “cloud,” facility of a child safety management organization 116, state agency 110, or otherwise. Training of the AI and/or ML engine may be performed by an operator submitting historical records thereto. In an embodiment, a neural network or other statistical analysis (e.g., k-th nearest neighbor) may be performed using the historical records, and then going forward, the AI engine may collect the answers from the foster children 102 and/or caregivers to assess existing matches along with potential matches of the foster children 102 and caregivers.

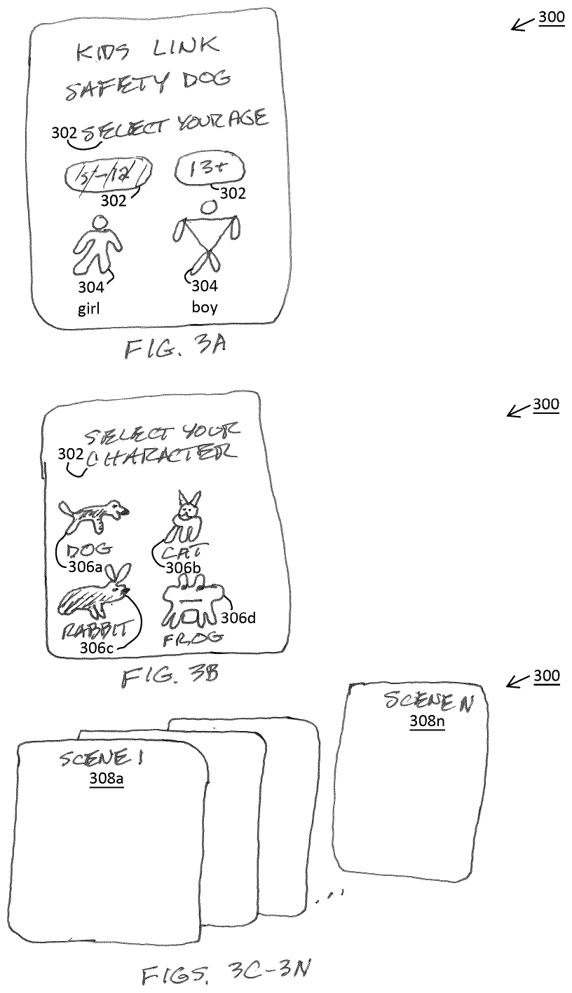

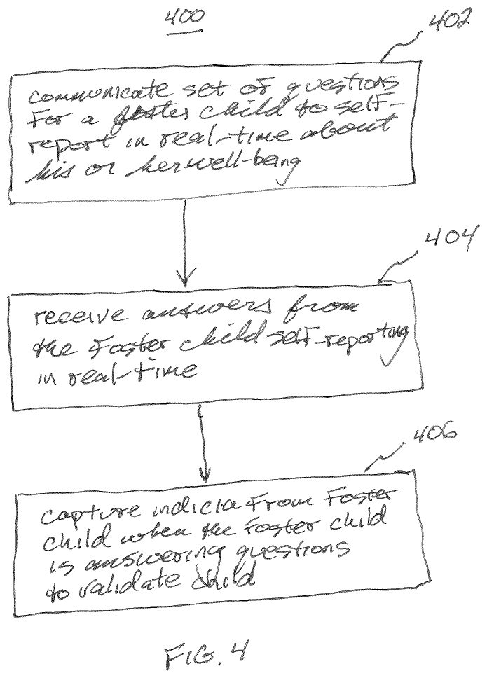

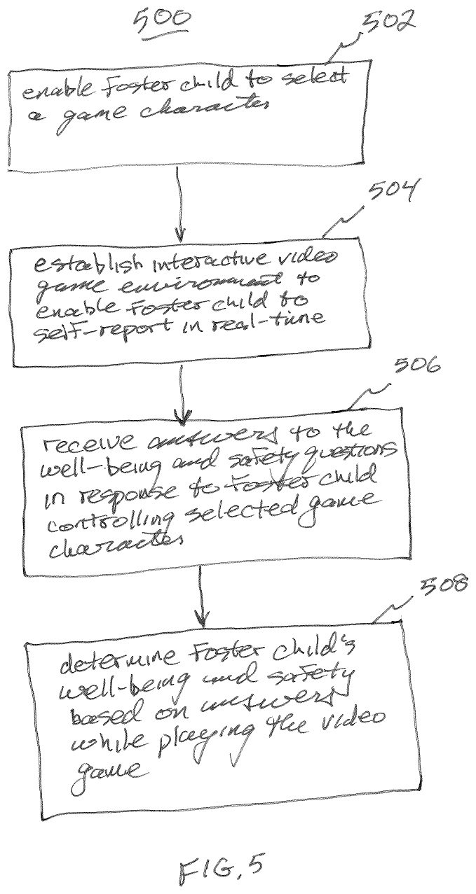

As further shown, data communications 118a-118d between the mobile electronic devices 114 being operated by the children 102, generally in the age range of 5 and 17 years old, to answer questions and/or playing a video game. The video game may be age appropriate for the children 102. For example, the game may be configured for children 5-6, 7-9, 10-12, 13-15, and 16-17 of age. The game may have different levels for the different age children 102. The rules of the game may be established for the children 102 to create rewards for themselves by answering the questions honestly whenever they play the game. The game is generally going to be made available to the foster children 102 during a case worker visit, but the game may alternatively be made available to the children 102 above a certain age at other times. The children 102 may collect points, rewards, or otherwise as the children 102 play the game and answer questions, as further described with regard to FIG. 3. The data communications may be from a computer on the communications network 120 communicating information, such as the questions or game environment, to the mobile electronic device(s) 114. In response to the foster children 102 answering the questions, data, including the indicia associated with the foster child (and optionally the case worker 112) may be communicated back to the computing system.

In an embodiment, rather than using a central data repository (e.g., database), a blockchain solution may be utilized to store and secure the questions and answers. Each foster child 102 may have his or her own blockchain, which may also be maintained by the agency 110 and/or management organization 116. The data stored in the blockchain may be secured such that a key to the blockchain is available to a limited number of people.

With regard to FIG. 2, a network environment 200 in which foster children 202 who are visited by case workers 204 can answer questions 206, optionally embedded into a video game 208, thereby providing the foster children 202 with a “safe space” to honestly answer the questions 206 that may thereafter be used by the agency to ensure safety and well-being of the foster kids 202 is shown. A child safety server 210 may be configured with a processor 212 that executes software for performing the processes and supporting the questions 206 and video game 208 described herein. The processor 212 may be in communication with a non-transitory memory 214, input/output (I/O) unit 216, and storage unit 218 that stores information therein. The processor 212 of the server 210 may configured to manage data, such as video game scenes, question data, foster children data, case worker data, etc., and communicate information (e.g., game data, question data, etc.) via data communications 220 to mobile electronic devices 222 that the foster children 202 use to self-report in real-time. The mobile electronic devices 222 may be those of case workers 204. In an embodiment, children 202 above a certain age may be able to access the video game 208 to provide answers 224 to more personal update questions, as opposed to simply mandated reporting questions, via their own electronic devices 222 (e.g., via a mobile phone or computer). It should be understood that a wide range of access to the video game 208 may be possible. In response to the foster children 202 answering the questions via the mobile electronic devices 222, the mobile electronic devices 220 may communicate answers 224 back to a server 208 operated by the child safety management organization (e.g., organization 116 of FIG. 1) or server 208 located in the “cloud.” The answers 224 may be communicated one at a time or after all of the questions 206 have been answered. The communications 220 may be made in a variety of formats, including short message services (SMS), email, data packets, or any other data format, as understood in the art. In an embodiment, if the foster child 202 is playing the video game 208, then the data may be communicated during play or after completion of the game (e.g., level).

With regard to FIGS. 3A-3N (collectively FIG. 3), screen shots of an illustrative video game 300 in which questions 302 are able to be asked of foster kids, thereby allowing the foster kids to self-report in real-time are shown. The video game 300 may enable the foster children to answer some basic questions 302, such as selecting his or her age (e.g., 5-12, or specific age), gender (e.g., optionally graphically as female 304a or male 304b), or otherwise. The video game 300 may also enable the foster child to select a character 306, such as an animal (e.g., dog 306a, cat 306b, rabbit 306c, frog 306d, etc.), to use in the video game 300. In an embodiment, the game 300 and/or questions 302 may begin by collecting an indicia (e.g., photo, video, biometric) of the foster child utilizing camera or other user identification feature of or connected to the mobile electronic device, thereby enabling the child safety management organization and/or state agency to verify the foster child is actually self-reporting and for future verification. As the foster child answers questions 302 by having the character 306 perform certain actions, such as run to a safe zone (e.g., school, foster care residence, etc.), mandate and non-mandate questions 302 may be answered. The mandate questions 302 may include:
1. How old are you?
2. How old are you right now (5-12, 13+)?
3. Do you like your teachers?
4. Do you like school?
5. Do you feel good today?
6. Do you want to be the best dancer or singer in school?
7. Do you like to play?
8. Do you like to read?
9. Do you like Art?
10. Do you like to talk?
11. Do you have friends?
12. Do you like movies?
13. Do you make friends easily?
14. How do you feel?
15. How did you feel this month?
16. Do you trust care givers?
17. Would you like a time machine?
18. Would you like a magic wand?
19. Do you like where you live?
20. Are you a good person?
21. Do you make your bed?
22. Do you wash the dishes?
23. Do you like to hang out with your friends?
24. Do you prefer to play video games or board games?
25. Do you prefer to draw or watch movies?

To answer the questions 302, the answers may be embodied in different manners, from text to video graphics. Some of the video graphics may be static, while other video graphics may be dynamic such that the skill and enjoyment levels may vary. In one embodiment, the video game 300 may be configured to store past information about individual foster kids so that future video game scenes may vary, thereby keeping the game interesting. Each of the scenes 1-N (308a-308n) in FIGS. 3C-3N may support answering a different question 302. Alternatively, a single scent may support answering each of the questions 302. Still yet, any number of scenes 308a-308n between 1 and N may be used to answer the questions 302. In an embodiment, the foster child may be provided with the ability to select a style of game that he or she would like to play. The game 300 may be set to enable the foster children to complete the answers within a certain time, such as 5 or 10 minutes. Gaming software may be part of the software executed by the processor 212 of FIG. 2 and include a scene generator module that generates scenes, which may be preconfigured scenes or dynamically generated in real-time for graphical user interface (GUI) with he selected character 306 displayed and optionally dynamically controlled by the foster kids when providing feedback questions.

In an embodiment, the server 210 of FIG. 2 of the child safety management organization 116 of FIG. 1 may be configured to collect and process the answers 224 of FIG. 2 from the foster children who answer the questions 206 while playing the video game 300. The processing may include simple processing to determine from the current answers whether the foster child has any health or safety issues. In another embodiment, the processing may include artificial intelligence to identify trends of the foster child over time and/or categorize the foster child as a type or gender of foster child with certain types of safety, health, or other possible concerns.

With regard to FIG. 4, a flow diagram of an illustrative process 400 for foster kids to play games on a mobile electronic device when answering questions for use in ensuring the foster kids' safety and well-being while in residential child care is shown. The process 400 may start at step 402, where a set of questions may be communicated via a communications network to a mobile device for a foster child to self-report in real-time about his or her well-being. The questions may be presented in a video game, graphical format, or text format. If in a video game, the foster child may play the video game and answer the questions while playing. The goal of the game may be to collect points, coins, collect items (e.g., friends, food, etc.), complete missions, or otherwise.

At step 404, answers may be received from the foster child who is self-reporting in real-time. By self-reporting in real-time, the foster child feels less pressure than if an adult, such as a case worker or foster parent, is asking the questions. If the child is playing a video game, then the foster child may feel even less pressure and be more entertained than if the questions are being asked in text. Moreover, for children who cannot yet read or read well, then the video game may allow those foster children to feel more comfortable and be able to answer the questions without adult assistance. Additionally, the game may help younger children learn to read or otherwise.

At step 406, indicia (e.g., image, biometric, video, or otherwise) of the foster child may be captured and stored when the foster child is answering questions, thereby validating or enabling someone to validate the child. In an embodiment, a biometric reader may enable automatic validation of the child. In an embodiment, if the child is not validated, then the mobile electronic device may prevent the questions in the form of a video game or otherwise from being asked. In yet another embodiment, the case worker's schedule may be checked to confirm that the case worker is scheduled to be with the foster child. The answers and indicia may be communicated back to a server via a communications network. In an embodiment, if a blockchain storage system is utilized, then the questions and/or answers along with any other data (e.g., indicia of the foster child) may be stored in a data block of the blockchain and added thereto. In an embodiment, the blockchain may be associated with the foster child, child safety management organization, state agency, foster parents, or otherwise. The blockchain may reside on any number of electronic devices, thereby being accessible in the future and prevent the collected answers and data from being erased or altered.

The process may further include dynamically altering a next question, optionally in a scene or a scene change, in response to receiving an answer from a question. An identifier of a case worker who is administering the set of questions to the foster child may be received so as to validate the case worker when the child is self-reporting in real-time. An identifier of the case worker may include a name or identifier of the case worker in association with the answers. Capturing the indicia may include capturing an image of the foster child.

The process may further include automatically confirming that the indicia is associated with the foster child, and determine that the case worker is scheduled to meet with the foster child. An automatic determination as to whether the foster child has had a change in his or her well-being or safety based on comparing the answers received to historical answers, and in response to determining that the well-being or safety has changed by a predetermined amount, a notification may be communicated to the case worker, thereby allowing for the case worker to address the issue in a proactive manner, for example.

The automatic determining as to whether the foster child has had a change in his or her well-being or safety may include executing an artificial intelligence engine that factors in the child's environment, duration of time that the foster child has been in the residence, duration of time that the foster child has been in the school, and age of the foster child. The questions and answers may be stored in a blockchain accessible to case worker and state regulators for future evaluation.

With regard to FIG. 5, a flow diagram of an illustrative process 500 for operating a video game may start at step 502 by enabling a foster child to select a game character is shown. At step 504, an interactive video game environment in which the selected game character is to interact may be established to enable the foster child to self-report in real-time answers to questions about his or her well-being and safety on a mobile electronic device. At step 506, answers to the well-being and safety questions in response to the foster child controlling the selected game character in the video game environment may be received. The foster child's well-being and safety may be determined based on his or her answers while playing the video game at step 508.

Establishing an interactive video game environment may include creating scenes of a house, foster parents, school, and streets in which the selected game character is able to be moved. Establishing the interactive video game environment may include creating features that move, where the features may be associated with possible answers to questions and with which the selected game character is to interact for the foster child to select as answers to questions.

Establishing the interactive video game environment may include scenes of an adventure for the selected game character to travel and answer questions while the foster child is playing the video game. The scenes may include a school scene, a home scene, and a scene in which parents are displayed. The scenes may show other characters of similar types to the selected game character. The selected game character may be an animal, and the other characters may include at least one of the same type of animal.

The process may further include displaying and/or generating audible questions within the video game to which the foster child is self-reporting in real-time about his or her well-being within residential care by when playing the video game on the mobile electronic device. An indicia may be captured by the mobile electronic device from the foster child when the foster child is playing the video game, thereby providing a validation that the foster child self-reported in real-time. The video game may automatically select a first scene or a second scene in response to the foster child causing the game character to answer a well-being or safety question with a corresponding first answer or a second answer. The first scene or the second scene may provide different game scenarios with different questions.

One embodiment of a video game for protecting foster kids may include a selectable a game character for a foster child to select, an interactive video game environment in which the selected game character is to interact to enable the foster child to self-report in real-time answers to questions about his or her well-being and safety on a mobile electronic device, input features for the foster child to submit answers to the well-being and safety questions in response to the foster child controlling the selected game character in the video game environment, and a module configured to process the foster child's well-being and safety based on his or her answers while playing the video game.

The video game may include a scene generation module configured to create scenes of a house, foster parents, school, and streets in which the selected game character is able to be moved. An interactive features module may be configured to create features that move, the features being associated with possible answers to questions and with which the selected game character is to interact for the foster child to select as answers to questions.

A scenes generation module may be configured to generate scenes of an adventure for the selected game character to travel and answer questions while the foster child is playing the video game. The scenes may include a school scene, a home scene, and a scene in which parents are displayed. The scenes may show other characters of similar types to the selected game character. The selected game character may be an animal, and the other characters include at least one of the same type of animal. The selected game character may alternatively be a person or object.

A question display module may be configured to display and/or generate audible questions within the video game to which the foster child is self-reporting in real-time about his or her well-being within residential care by when playing the video game on the mobile electronic device. An indicia capture module may be configured to capture an indicia from the foster child using the mobile electronic device when the foster child is playing the video game, thereby providing a validation that the foster child self-reported in real-time. A scene selection module may be configured to automatically select a first scene or a second scene in response to the foster child causing the game character to answer a well-being or safety question with a corresponding first answer or a second answer. The first scene or the second scene provides different game scenarios with different questions.

As used herein, the singular forms “a,” “an,” and “the” are intended to include the plural forms as well, unless the context clearly indicates otherwise. Also, the plural form of “teeth” may be construed as meaning one or more tooth.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

The previous description is of various preferred embodiments for implementing the disclosure, and the scope of the invention should not necessarily be limited by this description. The scope of the present invention is instead defined by the claims.

What is claimed:

1. A method for protecting foster kids, said method comprising:
communicating, via a communications network, a set of questions for a foster child to self-report in real-time about his or her well-being within residential care by answering the questions via a mobile electronic device;
receiving, via the communications network from the mobile electronic device, answers from the foster child who is self-reporting in real-time; and
capturing, by the mobile electronic device, an indicia from the foster child when the foster child is answering the questions, thereby providing a validation that the foster child self-reported in real-time.

2. The method according to claim 1, further comprising altering a next question in response to receiving an answer from a question.

3. The method according to claim 1, further comprising receiving an identifier of a case worker who is administering the set of questions to the foster child.

4. The method according to claim 1, wherein receiving an identifier of the case worker includes receiving a name or identifier of the case worker in association with the answers.

5. The method according to claim 1, wherein capturing the indicia includes capturing an image of the foster child.

6. The method according to claim 1, further comprising automatically:
confirming that the indicia is associated with the foster child; and
determining that the case worker is scheduled to meet with the foster child.

7. The method according to claim 1, further comprising:
automatically determining whether the foster child has had a change in his or her well-being or safety based on comparing the answers received to historical answers; and
in response to determining that the well-being or safety has changed by a predetermined amount, communicating a notification to the case worker.

8. The method according to claim 1, wherein automatically determining whether the foster child has had a change in his or her well-being or safety includes executing an artificial intelligence engine that factors in the child's environment, duration of time that the foster child has been in the residence, duration of time that the foster child has been in the school, and age of the foster child.

9. The method according to claim 1, further comprising storing the questions and answers in a blockchain accessible to case worker and state regulators for future evaluation.

10. A method of operating a video game for protecting foster kids, said method comprising:
enabling a foster child to select a game character;
establishing an interactive video game environment in which the selected game character is to interact to enable the foster child to self-report in real-time answers to questions about his or her well-being and safety on a mobile electronic device;
receiving answers to the well-being and safety questions in response to the foster child controlling the selected game character in the video game environment; and
determining the foster child's well-being and safety based on his or her answers while playing the video game.

11. The method according to claim 10, wherein establishing an interactive video game environment includes creating scenes of a house, foster parents, school, and streets in which the selected game character is able to be moved.

12. The method according to claim 10, wherein establishing the interactive video game environment includes creating features that move, the features being associated with possible answers to questions and with which the selected game character is to interact for the foster child to select as answers to questions.

13. The method according to claim 10, wherein establishing the interactive video game environment includes scenes of an adventure for the selected game character to travel and answer questions while the foster child is playing the video game.

14. The method according to claim 13, wherein the scenes include a school scene, a home scene, and a scene in which parents are displayed.

15. The method according to claim 14, wherein the scenes show other characters of similar types to the selected game character.

16. The method according to claim 15, wherein the selected game character is an animal, and the other characters include at least one of the same type of animal.

17. The method according to claim 10, further comprising displaying and/or generating audible questions within the video game to which the foster child is self-reporting in real-time about his or her well-being within residential care by when playing the video game on the mobile electronic device.

18. The method according to claim 10, further comprising capturing, by the mobile electronic device, an indicia from the foster child when the foster child is playing the video game, thereby providing a validation that the foster child self-reported in real-time.

19. The method according to claim 10, further comprising automatically selecting a first scene or a second scene in response to the foster child causing the game character to answer a well-being or safety question with a corresponding first answer or a second answer.

20. The method according to claim 19, wherein the first scene or the second scene provides different game scenarios with different questions.

21. A video game for protecting foster kids, said video game comprising:
a selectable a game character for a foster child to select;
an interactive video game environment in which the selected game character is to interact to enable the foster child to self-report in real-time answers to questions about his or her well-being and safety on a mobile electronic device;
input features for the foster child to submit answers to the well-being and safety questions in response to the foster child controlling the selected game character in the video game environment; and
a module configured to process the foster child's well-being and safety based on his or her answers while playing the video game.

22. The video game according to claim 21, wherein a scene generation module configured to create scenes of a house, foster parents, school, and streets in which the selected game character is able to be moved.

23. The video game according to claim 21, further comprising an interactive features module configured to create features that move, the features being associated with possible answers to questions and with which the selected game character is to interact for the foster child to select as answers to questions.

24. The video game according to claim 21, wherein further comprising a scenes generation module configured to generate scenes of an adventure for the selected game character to travel and answer questions while the foster child is playing the video game.

25. The video game according to claim 24, wherein the scenes include a school scene, a home scene, and a scene in which parents are displayed.

26. The video game according to claim 25, wherein the scenes show other characters of similar types to the selected game character.

27. The video game according to claim 26, wherein the selected game character is an animal, and the other characters include at least one of the same type of animal.

28. The video game according to claim 21, further comprising a question display module configured to display and/or generate audible questions within the video game to which the foster child is self-reporting in real-time about his or her well-being within residential care by when playing the video game on the mobile electronic device.

29. The video game according to claim 21, further comprising an indicia capture module configured to capture an indicia from the foster child using the mobile electronic device when the foster child is playing the video game, thereby providing a validation that the foster child self-reported in real-time.

30. The video game according to claim 21, further comprising a scene selection module configured to automatically select a first scene or a second scene in response to the foster child causing the game character to answer a well-being or safety question with a corresponding first answer or a second answer.

31. The video game according to claim 30, wherein the first scene or the second scene provides different game scenarios with different questions.
